(19) United States
(12) Patent Application Publication
(10) Pub. No.: US 2003/0035563 A1
(43) Pub. Date: Feb. 20, 2003

(54) Audio signal junction box assembly

(76) Inventor: Lung-Tan Chen, Taichung (TW)

Correspondence Address: Andrew CHENG, 22928 Estoril Drive #5, Diamond Bar, CA, 91765, US

(21) Appl. No.: 09/930,569

(22) Filed: Aug. 15, 2001

(51) Int. Cl. H04R 25/00; H04R 1/02

(52) U.S. Cl. 381/386; 381/388; 381/395; 381/189

(57) ABSTRACT

The audio signal junction box assembly comprises a housing adapted to be mounted within an opening of a ceiling structure, and defines an inner space with side wall and ended with a top surface having at least an opening therein. An electrical connector arranged on the top surface. A cable arranged in the trench of the top surface is connected to one end the connector and a branching wire is connected to the connector at the other end and extending through the opening and into the inner space of the housing. The connector is enclosed by a lid attached to the recess.

### FIELD OF THE INVENTION

The present invention relates to an audio junction box assembly, and more particularly to an audio junction box having a connector integrally mounted thereof so as to facilitate easy and efficient wiring.

### DESCRIPTION OF THE PRIOR ART

As clearly shown in FIG. 1, wiring diagram of a public broadcasting system in a building generally includes an amplifier (40) from which two transformers (42) are arranged in parallel. Finally, each speaker 42 is connected to the transformer (42) so as to output the signal. Generally, this public broadcasting system is arranged in a ceiling configured by steel frame.

However, in order to prevent a fire entering into the ceiling from the speaker, each speaker has to be provided with a back junction box, which is fire-proof. By this arrangement, other wiring system, such as electricity wires and data transmission wires arranged within the ceiling can be prevented from being burned out and damaged.

As shown in FIG. 2, a conventional junction box includes inner and outer shells (10, 11) in which a ceiling (12) is sandwiched therebetween. An Input three-strand signal wire (13) is directed into the shells (10, 11) by the technician. The technician then assembles a ceramic connector (14) on which the three-strand wires (13) is connected. Finally, a speaker (18) is connected to the connector (14). The three-strand signal wire (13) includes one grounding wire (17) which is grounded. In addition, an Output three-strand wire 15 is connected to the connector (14) and directed from the shells (10, 11) into the ceiling (12) for next speaker.

FIG. 3 discloses another embodiment of the prior art. The junction box (20) is assembled to an opening (23) of a ceiling by a pair of mounting brackets (21, 22). An Input three-strand wire (24) is directed into the junction box (20) from the ceiling. The junction box (20) further is assembled with a ceramic connector (25) on which the three-strand wire (24) is connected. Finally, an Output three-strand wire (26) is directed from the connector (25) into the ceiling for next speaker.

It can be easily found that the junction box shown in FIGS. 2 and 3 all need to direct the Input and Output wires to-and-from between the junction box and the ceiling by the technician working thereon. This is really laborious.

### SUMMARY OF THE INVENTION

It is an object of this invention to provide an audio junction box in which a connector is integrally assembled thereto so as to facilitate quick and efficient mounting of the speaker thereto.

In order to achieve the object set forth, an audio junction box assembly in accordance with the present invention comprises a housing adapted to be mounted within an opening of a ceiling structure, and defines an inner space with side wall and ended with a top surface having at least an opening therein. An electrical connector arranged on the top surface. A cable is connected to one end the connector and a branching wire is connected to the connector at the other end and extending through the opening and into the inner space of the housing. The connector is enclosed by a lid attached to the recess.

### BRIEF DESCRIPTION OF THE DRAWINGS

Other objects and further features of the present invention will be apparent from the following detailed description when read in conjunction with the accompanying drawings, in which:

FIG. 1 is a wiring diagram of a public broadcasting system;

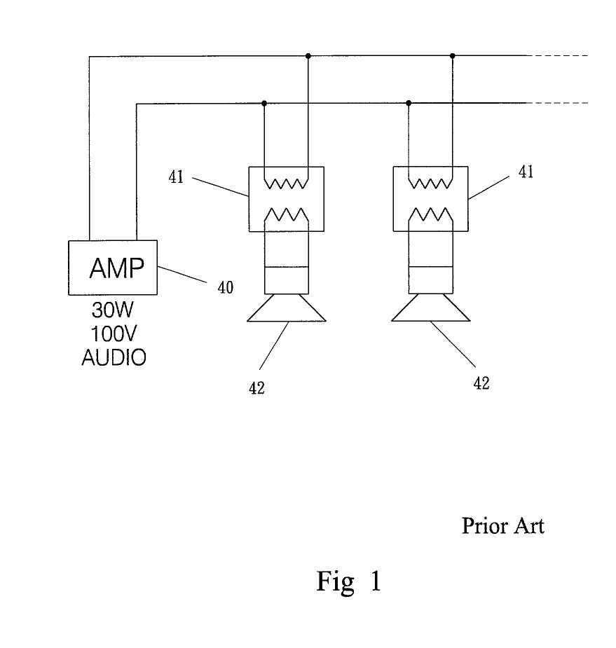

FIG. 2 is a first embodiment of a junction box used to mount a speaker;

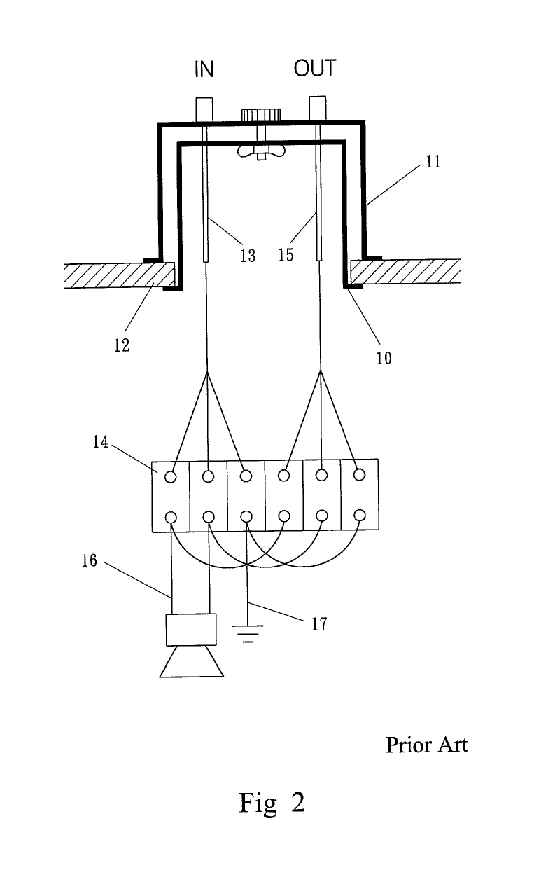

FIG. 3 is a second embodiment of a junction box used to mount a speaker;

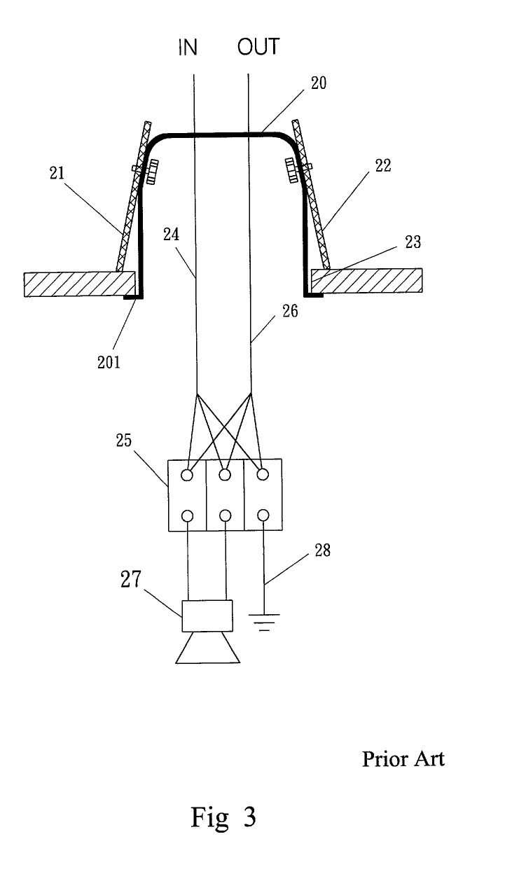

FIG. 4 is a perspective view of an audio junction box in accordance with the present invention;

FIG. 5 is an exploded view of FIG. 4;

FIG. 6 similar to FIG. 5 with partial of the junction box being cutoff for clarity;

FIG. 7 is a side illustration view showing the junction box of FIG. 4; and

FIG. 8 is similar to FIG. 7 and shows a second embodiment of the present invention.

### DETAILED DESCRIPTION OF PREFERRED EMBODIMENT

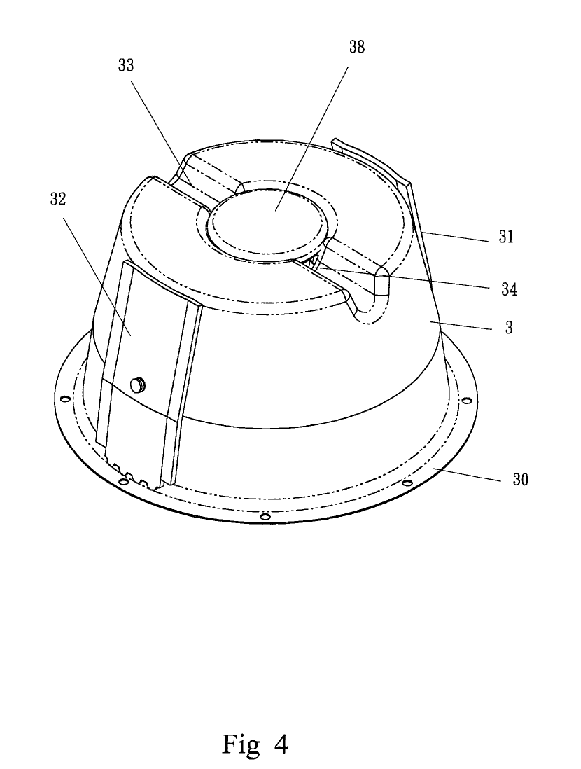

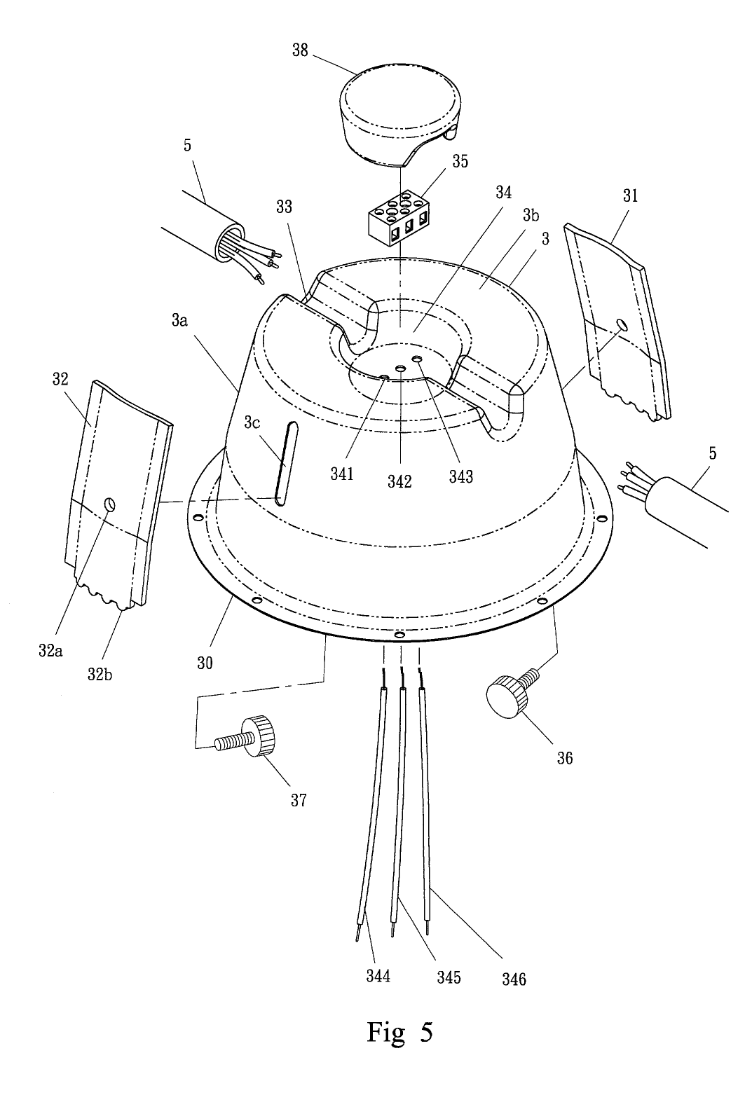

Referring to FIGS. 4 to 8, specially to FIG. 5, an audio junction box assembly 1 in accordance with the present invention comprises a housing 3 adapted to be mounted within an opening of a ceiling structure, and defines an inner space with side wall 3a and ended with a top surface 3b. A recess 34 is defined in the top surface 3b and defines three holes 341, 342 and 343 therein. The top surface 3b further defines a trench 33 extending through the top surface 3b and in communication with the recess 34. Signal cable 5 having signal wires (not labeled) can be assembled within the trench 33. A lid 38 is provided to enclose the recess 34.

An electrical connector 35 is mounted within the recess 34 and is electrically connected to the cable 5. The connector 35 is provided with connecting ports (not labeled) aligning with the holes 341, 342 and 343. After the connector 35 is connected to the cable 5, the lid 38 is attached to the recess 34 so as to enclose the recess 34 and also serve to protect the connector 35 mounted within the recess 34.

The housing 3 of the junction box assembly 1 is securely assembled to the ceiling by means of a pair of mounting brackets 32. The side wall 3a of the housing 3 is provided with a pair of slots 3c (only one is shown) in which a pair of mounting bolt 36, 37 extending threrethrough. The mounting bolt 36 is engaged to a mounting hole 32a of the bracket 32 to as to position the housing 3. The slot 3c has a certain length for adjustment so as to ensure an end 32b of the bracket 32 can properly anchored on the ceiling. As shown in FIG. 5 the housing 3 includes a flange 30 which bears on another side of the ceiling. By this arrangement, the housing 3 is securely attached onto the ceiling.

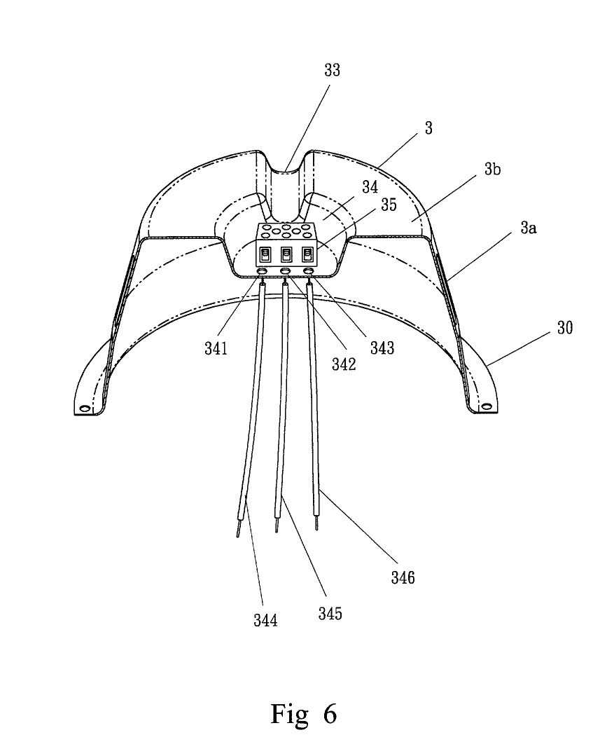

Referring to FIG. 6, after the connector 35 is properly seated within the recess 34, signal wires 344 and 345 are routed from inside of the housing 3 to the connector 35 located within the recess 34 through the holes 341, 342. A ground wire 346 is also connected to the connector 35 through the hole 343.

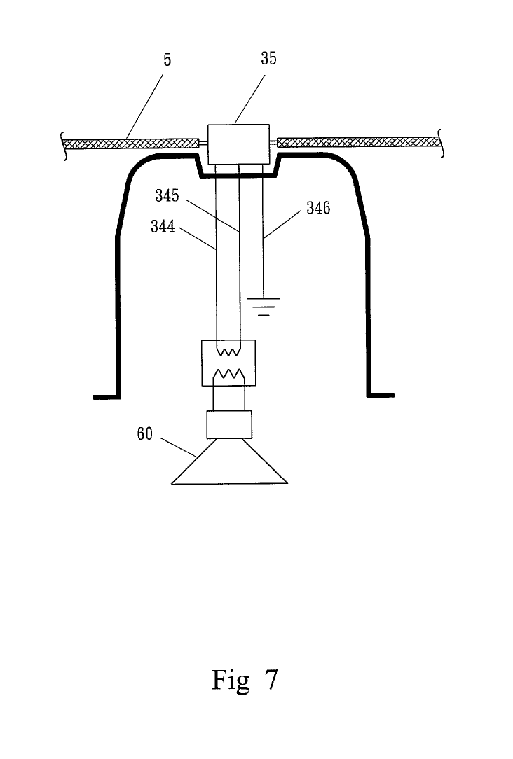

Referring to FIG. 7, since the signal wires 344, 345 are pre-mounted within the housing 3, the speaker 60 can be readily assembled thereto and electrically connected to signal wires 344, 345 and the ground wire 346 without further laborious work.

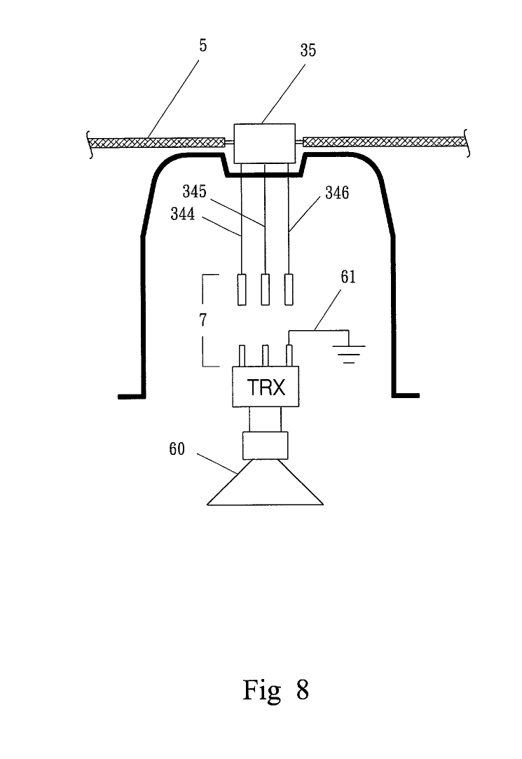

Referring to FIG. 8, a TRX connector 7 is arranged within the housing 3. By this arrangement, the speaker 60 can be quickly connected with the signal wires 344, 345 and 346 and properly be grounded through the ground wire 61.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

I claim:

1. An audio junction box assembly, comprising
a housing adapted to be mounted within an opening of a ceiling structure, and defining an inner space with side wall and ended with a top surface;
an electrical connector arranged on the top surface;
at least a cable connected to the connector; and
at least a branching wire connected to the connector and extending into the inner space of the housing.

2. The audio junction box assembly as recited in claim 1, wherein the top surface defines a recess in the top surface and in which the connector is mounted therein.

3. The audio junction box assembly as recited in claim 2, wherein a lid is provided to enclose the recess.

4. The audio junction box assembly as recited in claim 2, wherein a trench is defined in the top surface and is in communication with the recess for receiving the cable therein.

5. The audio junction box assembly as recited in claim 1, wherein the junction box further includes a mounting bracket for positioning the junction box to the ceiling structure.

6. The audio junction box assembly as recited in claim 5, wherein at least a locking device is provided to attach the housing to the mounting bracket.

7. An audio junction box, comprising
a housing adapted to be mounted within an opening of a ceiling structure, and defining an inner space with side wall and ended with a top surface;
a recess defined in the top surface adapted to receiving a connector therein.

8. The audio junction box as recited in claim 7, wherein a trench extends through the top surface and in communication with the recess for receiving a cable therein.

9. The audio junction box as recited in claim 7, wherein the top surface includes at least an opening in communication with the inner space of the housing.

10. The audio junction box assembly, comprising
a housing adapted to be mounted within an opening of a ceiling structure, and defining an inner space with side wall and ended with a top surface;
a first electrical connector arranged on the top surface adapted to be electrically connected to a cable;
a second electrical connector arranged within the housing and electrically connected to the first connector and adapted to be connected to a speaker.
